(19) United States
(12) Patent Application Publication
(10) Pub. No.: US 2022/0025472 A1
(43) Pub. Date: Jan. 27, 2022

(54) COMPOSITIONS BASED ON MAPLE SAP, VEGETABLE JUICE OR FRUIT JUICE, AND PROCESS FOR MANUFACTURING SAME

(71) Applicant: LES TECHNOLOGIES CLDUFOUR INC., SAINTE-LUCE-SUR-MER (CA)

(72) Inventors: Claude DUFOUR, Sainte-Luce-Sur-Mer (CA); Ali FADI, Laval (CA)

(73) Assignee: LES TECHNOLOGIES CLDUFOUR INC., SAINTE-LUCE-SUR-MER, QC (CA)

(21) Appl. No.: 17/252,718

(22) PCT Filed: Jul. 5, 2019
(86) PCT No.: PCT/CA2019/050930

§ 371 Date: Oct. 12, 2021

(30) Foreign Application Priority Data
Jul. 6, 2018 (CA) 3,010,832
Oct. 1, 2018 (CA) 3,019,455

(51) Int. Cl. C13B 50/00; A23L 29/30; A23L 27/00; A23L 33/125

(52) U.S. Cl. CPC C13B 50/00; A23L 29/30; A23V 2002/00; A23L 33/125; A23L 27/88

(57) ABSTRACT

The application relates to compositions based on maple sap, fruit juice and/or vegetable juice having a high added value. In particular, said compositions have high concentrations in polyphenols, phosphorus, magnesium, calcium and potassium, for example. These concentrations are higher than those in maple sap made by previous traditional or commercial processes and higher than those in fruit or vegetable juices or syrups. Furthermore, said compositions have an antioxidant effect that is also higher than that in commercial maple sap made on an industrial or small scale and higher than that in commercial fruit or vegetable juices or syrups. The application also relates to processes for making such compositions.

### REFERENCE TO OTHER RELATED APPLICATIONS

The present application claims a priority of Canadian application No. 3,010,832 filed on 6 Jul. 2018, and Canadian application No. 3,019,455 filed on 1 Oct. 2018. These documents are also incorporated in their entirety by reference.

### FIELD OF THE DISCLOSURE

The products of maple, fruits and vegetables are renowned for their taste and their varied composition, which are highly sought after these days by industry. Increasingly many products derived from maple, fruits and vegetables have appeared on the market, and new innovations are being regularly explored in this field. It was therefore time to propose alternatives to the existing products and methods by the development of new products with added value, thus stimulating the economic activity of the maple industry.

### SUMMARY OF THE DISCLOSURE

It has been found that the compositions and methods of the present application make it possible to promote the products of maple, fruits and vegetables and more specifically their organoleptic properties, including the taste and flavor of maple, fruits and vegetables as compared to the products made by traditional methods from maple, fruits and vegetables. The methods of the present disclosure make it possible to further enhance these properties in a product or a preparation which can form the basis for many derived products. The product or the preparation so obtained may serve as a basis for developing and launching products of higher added value as compared to the products of maple, fruits and vegetables presently on the market. These products of high added value also have various interesting contents in terms of certain compounds as compared to the products obtained by traditional methods. These products of high added value may offer advantages in the area of nutrition and health.

The present application involves a composition based on concentrated maple sap having a polyphenol content of around 0.8 to 10 mg per g of sucrose.

The present application also involves a composition based on concentrated maple sap having a manganese content of around 0.05 to 0.7 mg per g of sucrose.

The present application also involves a method for preparation of a concentrated composition based on maple sap in which one evaporates under vacuum a maple sap or a maple sap concentrate so as to obtain a non-caramelized syrup;
one subjects the non-caramelized syrup to a crystallization so as to obtain sugar crystals and said concentrated composition based on maple sap; and
one separates the sugar from said concentrated composition based on maple sap.

The present application also involves a method for preparation of a concentrated composition based on fruit juice, fruit juice concentrate, vegetable juice, and/or vegetable juice concentrate, in which
one evaporates under vacuum the fruit juice, fruit juice concentrate, vegetable juice, and/or vegetable juice concentrate in order to obtain a non-caramelized syrup;
one subjects the non-caramelized syrup to a crystallization in order to obtain sugar and said concentrated composition based on fruit juice, fruit juice concentrate, vegetable juice, and/or vegetable juice concentrate; and
one separates the sugar from said concentrated composition based on fruit juice, fruit juice concentrate, vegetable juice, and/or vegetable juice concentrate.

The present application involves a composition based on fruit juice, fruit juice concentrate, vegetable juice, and/or vegetable juice concentrate, having a polyphenol content of around 0.8 to 10 mg per g of sucrose.

The present application also involves a composition based on fruit juice, fruit juice concentrate, vegetable juice, and/or vegetable juice concentrate, having a manganese content of around 0.05 to 0.7 mg per g of sucrose.

### BRIEF DESCRIPTION OF THE FIGURES

The following figures are presented solely as an example and are not limiting.

FIG. 1: Method according to the present disclosure for the production of an enriched maple composition.

FIG. 2: Vacuum layout for the production of non-caramelized compositions and syrup in the laboratory.

FIG. 3: Evaporator Anhydro (left) and evaporator APV (right) used for the production of non-caramelized syrup

FIG. 4: Filter press used for the filtration of the syrup at the factory.

FIG. 5: Crystallizers used at the factory. Pilot plant scale (left); semi-industrial scale (right).

FIG. 6: Stages in the crystallization of sugar from the non-caramelized syrup.

FIG. 7: Centrifuge used at the pilot plant for the separation of the composition and sugar crystals.

FIG. 8: Miniature electrical evaporator used for the production of the maple sap on the pilot plant scale.

FIG. 9: Description of the preliminary tests performed in the laboratory.

FIG. 10: Description of the tests performed on a small scale in the laboratory and on the pilot plant scale at the factory.

FIG. 11: Description of the tests performed on the semi-industrial scale.

FIG. 12: Concentration of polyphenols in the different compositions produced.

FIG. 13: Content of principal mineral ions in the compositions produced on different scales by the two methods of thermal crystallization and crystallization by cooling.

FIG. 14: Profiles of volatile compounds detected in the compositions produced in the pilot plant by the method of crystallization by cooling.

FIGS. 15A and 15B: Polyphenol content and antioxidant activity of different syrup products.

FIGS. 16A, 16B and 16C: Content of principal mineral ions in the caramelized syrups produced on the pilot evaporator and that of non-caramelized product on the APV.

FIG. 17: Profile of volatile compounds in the caramelized syrups produced on the pilot evaporator.

FIG. 18: Profile of volatile compounds detected in the condensates during the preparation of the composition by the two methods of crystallization.

FIG. 19: Plot of the polyphenol concentration in the different products obtained on the production chain of the maple composition.

FIG. 20: Plot of the antioxidant activity in the different products on the production chain of the maple composition.

FIGS. 21A, 21B and 21C: Content of principal mineral ions of the different products on the production chain for the maple composition.

FIG. 22: photos of compositions produced by cooling on the pilot plant and semi-industrial scale (the fine crystals are separated from the composition after freezing).

FIG. 23: Photos of different products coming from the manufacturing process for the maple composition and its derivatives.

FIG. 24: Concentration of polyphenols in different compositions produced from black currant juice.

### DETAILED DESCRIPTION OF THE PRESENT DISCLOSURE

For example, the compositions of the present application may have a content of polyphenols in mg per g of sucrose of around 0.8 to 6.0; of around 0.8 to 4.0; of around 1.0 to 7.0; of around 1.2 to 7.0; of around 1.4 to 5.3; of around 2.0 to 5.3; of around 1.0 to 4.0; of around 1.0 to 2.0; of around 1.2 to 4.0; of around 1.5 to 3.8 or of around 2.0 to 4.0.

For example, the compositions of the present application may have a content of phosphorus in mg per g of sucrose of around 0.02 to 0.2 or of around 0.05 to 0.2.

For example, the compositions of the present application may have a content of magnesium in mg per g of sucrose of around 0.4 to 1.8 or of around 0.6 to 1.6.

For example, the compositions of the present application may have a content of iron in mg per g of sucrose of around 0.3 to 0.6.

For example, the compositions of the present application may have a content of manganese in mg per g of sucrose of around 0.02 to 0.7.

For example, the compositions of the present application may have a content of potassium in mg per g of sucrose of around 5 to 25; of around 8 to 25 or of around 10 to 25.

For example, the compositions of the present application may have a content of calcium in mg per g of sucrose of around 3 to 10 or of around 3 to 8.

For example, the compositions of the present application may have a content of manganese in mg per g of sucrose of around 0.05 to 0.7; of around 0.1 to 0.5 or of around 0.2 to 0.5.

For example, the compositions of the present application may have a content of manganese in mg per g of sucrose of around 0.05 to 0.7, they may also have a content of magnesium in mg per g of sucrose of around 0.3 to 1.8 or of around 0.35 to 1.8.

For example, the compositions of the present application may have a content of manganese in mg per g of sucrose of around 0.05 to 0.7, they may also have a content of phosphorus in mg per g of sucrose of around 0.02 to 0.2 or around 0.05 to 0.2.

For example, the compositions of the present application may be in liquid form.

For example, the compositions of the present application may be in solid form.

For example, the compositions of the present application may be in maple syrup form.

For example, the compositions of the present application may be in maple butter form.

For example, the compositions of the present application may be in maple sugar form.

For example, the compositions of the present application may have an antioxidant activity of at least 7000 or 7500 TE Eq., μM; of at least 8000 or 8500 TE Eq., μM; of at least 8000 or 9000 TE Eq., μM; of around 8000 to 20000 TE Eq., μM; of around 8000 to 15000 TE Eq., μM of around 8000 to 13000 TE Eq., μM or of around 10000 to 12500 TE Eq., μM.

For example, the crystallization of a method of the present application may be a vacuum crystallization.

For example, the crystallization of a method of the present application may be an evaporative crystallization.

For example, the crystallization of a method of the present application may be a thermal crystallization.

For example, the crystallization of a method of the present application may be a crystallization by cooling.

For example, in a method of preparation of the present application of a concentrated composition based on maple sap, fruit juice, fruit juice concentrate, vegetable juice, and/or vegetable juice concentrate, one may caramelize said concentrated composition in order to obtain a caramelized syrup.

For example, in a method of preparation of the present application of a concentrated composition based on maple sap, fruit juice, fruit juice concentrate, vegetable juice, and/or vegetable juice concentrate, said concentrated composition may be subjected to another crystallization in order to obtain sugar and another concentrated composition based on maple sap, fruit juice, fruit juice concentrate, vegetable juice, and/or vegetable juice concentrate. For example, said other concentrated composition based on maple sap, fruit juice, fruit juice concentrate, vegetable juice, and/or vegetable juice concentrate may be caramelized in order to obtain s caramelized syrup.

For example, the method of preparation of the present application of a concentrated composition based on maple sap, fruit juice, fruit juice concentrate, vegetable juice, and/or vegetable juice concentrate may further involve a drying of said concentrated composition based on maple sap, fruit juice, fruit juice concentrate, vegetable juice, and/or vegetable juice concentrate, or a drying of said other concentrated composition based on maple sap, fruit juice, fruit juice concentrate, vegetable juice, and/or vegetable juice concentrate.

For example, the drying of a method of the present application may be done by lyophilization, by atomization or in an oven or a tunnel.

For example, in a method of the present application one may evaporate under vacuum, using a multi-stage evaporator.

For example, in a method of the present application one may evaporate under vacuum said maple sap or said maple sap concentrate while recovering the aromas of said maple sap or said maple sap concentrate by using an aroma collector.

For example, in a method of the present application one may evaporate under vacuum said fruit juice, fruit juice concentrate, vegetable juice, and/or vegetable juice concentrate while recovering the aromas from said fruit juice, fruit juice concentrate, vegetable juice, and/or vegetable juice concentrate by using an aroma collector.

For example, the fruits mentioned in the present application may be selected from among blueberries, cranberries, blackberries, black currants, aronias, strawberries, raspberries, plums, apples, grapes, elderberries, honeyberries, litchi, apricots, dates, cherries, pomegranates figs, pears, peaches, gooseberries, lingonberries, quinces, oranges, limes, lemons, mangos, and nectarines.

For example, the fruits mentioned in the present application may be selected from among blueberries, cranberries, blackberries, black currants, aronias, strawberries, raspberries, plums, apples, grapes, elderberries, and honeyberries.

For example, the fruits mentioned in the present application may be selected from among blueberries, cranberries, blackberries, and black currants.

For example, the vegetables mentioned in the present application may be selected from among artichokes, olives, onions, potatoes, carrots, shallots, beets, cabbage, corn, tomatoes, peas, turnips, and rhubarb.

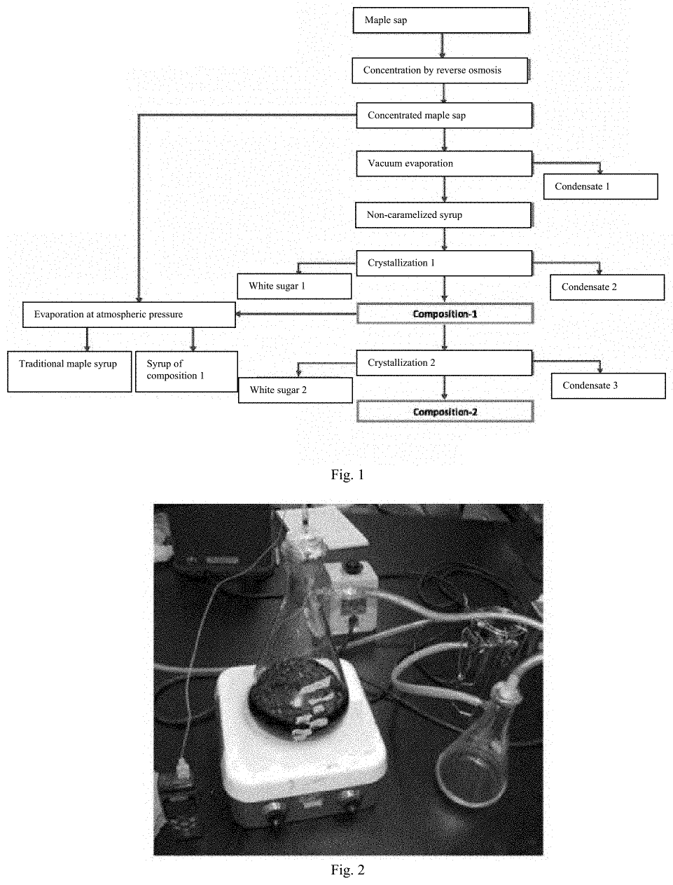

The methods of the present application may involve the removal of a portion of the sugars present in the syrup, which makes it possible to raise the content of maple, fruit or vegetable compounds in the finished product, namely, “the composition of maple/fruits/vegetables. In a first stage, one may transform a concentrate of maple sap, or a concentrate of fruit and/or vegetable juice into non-caramelized syrup on a vacuum evaporator. This transformation under vacuum and at low temperature makes it possible to reduce the degradation of the compounds of maple, fruits and/or vegetables present in the fresh sap or fresh juice, to prevent the caramelization of the sugars, and to lessen the risk of scorching the syrup. In a second stage, in order to reduce the sugar content, this syrup may undergo an extraction of the sugars by means of a vacuum crystallization in order to obtain a composition of maple, fruits and/or vegetables. One then obtains a liquid enriched in various natural compounds of maple, fruits and/or vegetables, but with a diminished sugar content. A composition reduced in sugar but enriched in other compounds may be of interest in the manufacture of products with high added value from maple, fruits and/or vegetables (polyphenols, aromas, etc). This may allow those who have a problem of diabetes or other problems associated with glycemia to eat products of maple, fruits and/or vegetables while reducing the risks to their health. It is important to mention that the feasibility tests were performed without the adding of sugar seeds (seeding) to the supersaturated syrup so as not to affect the taste of the finished product. Of course, such products could also be prepared by adding sugar seed (“seeding”), but the products so obtained may be less interesting in terms of their sugar content. The plan of the exemplary method for manufacturing the composition of maple is presented in FIG. 1. The person skilled in the art will understand that this plan may also be used for the processing of fruit juice, fruit juice concentrate, vegetable juice, and/or vegetable juice concentrate. In fact, the person skilled in the art will understand that all the processes, methods, schemes and techniques described in the present application with regard to the products of maple are applicable to fruit juice, fruit juice concentrate, vegetable juice, and vegetable juice concentrate. In fact, in all the processes, methods, schemes and techniques described in the present application one may replace the starting product of maple sap or maple sap concentrate (or various compositions of maple or those based on maple) with fruit juice, fruit juice concentrate, vegetable juice, and vegetable juice concentrate.

For example, the present disclosure involves the use of a composition such as that described in the present disclosure in order to enhance the flavor or the aroma.

For example, the present disclosure involves the use of a composition obtained by a method such as that defined in the present disclosure in order to enhance the flavor or the aroma.

For example, the method further involves, after having separated said sugar from said concentrated composition, a dilution of said concentrated composition in order to obtain a flavor or aroma enhancer.

For example, said concentrated composition may be diluted with water.

Tests were divided into different parts in order to control the method on different scales. In a first stage, preliminary tests were carried out in the laboratory, in order to see the feasibility and adapt the strategy to be used. After these preliminary tests, two primary methods of crystallization were carried out in the laboratory: the method of crystallization by thermal supersaturation and the method of crystallization by cooling. Both of these tests having shown positive results, they were transferred to the factory on a pilot scale. The tests on this scale revealed better results with the crystallization by cooling, which was applied on a large semi-industrial scale for the production of a larger volume of a first composition (composition 1). A portion of this composition was recrystallized on the pilot scale to produce a second composition (composition 2). After this, a second portion of composition 1 was used to produce a caramelized syrup of maple composition on a traditional evaporator. This latter was compared to a reference maple syrup produced from the same original concentrate used for the production of composition 1. It is of course possible to carry out the method of crystallization by supersaturation i.e., with the adding of sugar seed (crystallization seeding).

The principal objectives of the project were the following:
To evaluate the feasibility of producing a non-caramelized composition from the maple sap (concentrate).
To furnish a prototype of the product obtained.
To sketch out the characteristics of this composition.
To evaluate the characteristics of products derived from the maple composition.
To present a proof of concept for the production of the maple composition from a maple sap concentrate.

### Methodology

1. Sampling Process

The applicant supplied the team of the ACER Center with volumes of maple syrup and sap concentrate. These products had been gathered by the applicant from a maple tree farmer toward the end of the 2017 season. The list of the products received is presented in Table 1. The products had been frozen at −18° C. up to the time of their use. The concentrates were subdivided into three fractions, used for different sections of tests carried out in the laboratory, in a pilot plant, and on large scale.

TABLE 1
List of the concentrates and syrups
gathered and supplied by the client

| Collection | | Volume | | Number of | |
|---|---|---|---|---|---|
| date | Product | (L) | Brix (%) | containers | |
| 23 Apr. 2017 | Concentrate 1 | 108 | 20 | 27 of 4 | L |
| 26 Apr. 2017 | Concentrate 2 | 132 | 20 | Large number | |
| 27 Apr. 2017 | Concentrate 3 | 140 | 19 | of 4 L | |
| 28 Apr. 2017 | | 320 | 18 | 21 of 20 | L |
| 28 Apr. 2017 | Syrup | 9 | 66 | 2 of 4 | L |

2. Experimental Layout

During the tests in the laboratory and in the pilot plant, different instruments were used for the surveying of the characteristics of products and the process parameters, as indicated in Table 2.

TABLE 2
Instruments used for surveying the process

| | Name of the | |
|---|---|---|
| Measure | instrument | Make and model |
| Plotting of ° Brix | Manual | Fisher interval 0-32° Brix; |
| | refractometers | Fisher interval 28-52° Brix; |
| | | Fisher interval 45-82° Brix |
| | Electronic | Reichart 0-95° Brix |
| | refractometers | Atago 0-85° Brix |
| Plotting of | RTD | General DT80-2 |
| temperatures | | |
| Measurement of | Pressure manometer | 0-30 Po of mercury |
| vacuum | | |

2.1. Production of Syrup in the Laboratory

Preliminary tests were carried out for the production of non-caramelized maple syrup (under vacuum) on the laboratory scale. Containers of concentrate 1 at 20° Brix were thawed and then used. Likewise, diluted volumes of syrup at 20° Brix were used to evaluate the effect of the syrup matrix on the saturation of the sugar. The experimental arrangement consists of an Erlenmeyer flask of 2 L, placed on a hot plate (Corning, PC-101). This flask serves as a cooking vessel for the liquid processed under vacuum with a magnetic agitation. Another Erlenmeyer flask of 0.5 L or one of 1 L was connected to the first one, being under vacuum, in order to recover the vapor condensate. The vacuum used varied from 18 to 22 po Hg depending on its use elsewhere in the building. A RTD was submerged in the liquid in order to plot the boiling temperature throughout the testing.

The diluted syrup or the concentrate were heated under vacuum until a non-caramelized syrup was obtained at 66° Brix, and this was filtered under vacuum on a Buschner 40 μm filter (paper filter VWR #417). Table 3 shows the conditions for production of the syrups in the laboratory.

TABLE 3
Description of the conditions for production
of syrup in the laboratory

| | | Heating | Vacuum | |
|---|---|---|---|---|
| | Starting | temperature | applied | Method of |
| Raw material | ° Brix | (° C.) | (po Hg) | filtration |
| Syrup diluted | 20.4 | 71.5 | 21.5 | None |
| with water | | | | |
| Sap concentrate | 23.8 | 72.4 | 18.8 | Buschner vacuum |
| | | | | filter |

These tests made it possible to determine the preliminary conditions for production of syrup under vacuum, and also to test the layout which would serve for the crystallization tests.

2.2 Production of the Composition

The composition was produced from the non-caramelized syrup at 66° Brix that was obtained in various tests carried out on a small or a large scale. A spontaneous crystallization was initiated without the adding of a sugar seed to the cooked mass so as not to affect the taste of the finished product (composition). The development of the crystals was then carried out by the two types of crystallization tested: either by a thermal supersaturation or by cooling. The reason for testing these two methods is to examine the effect of the crystallization temperature on the taste and the characteristics of the finished product. For these two methods, many tests were carried out under different conditions, depending on the objective of each test.

### Production of the Composition in the Laboratory

The thermal supersaturation was carried out with the same layout as the one used to make the non-caramelized syrup in the laboratory. The non-caramelized syrup was heated under vacuum and under agitation until reaching a target ° Brix between 78 and 86%. The tests for crystallization by cooling involved cooling the saturated solution down to 40° C. Two methods of cooling were used. The first one involved cooling the cooked mass to room temperature, while the second one was carried out under controlled conditions. The temperature was lowered gradually by 3° C. per 15 minutes with the aid of a beaker submerged in a water bath for 3.5 h. The cooked mass was stirred continuously throughout the cooling with the aid of an agitator inserted into the beaker.

The sugar crystals were separated from the composition with the aid of a laboratory centrifuge outfitted with two types of rotors depending on the volume of liquid being processed. In certain cases, it was necessary to hydrate the solution of the supersaturated composition with a little bit of demineralized water in order to allow the separation of the crystals. The conditions of crystallization that were tested during laboratory experiments are presented in Table 4.

TABLE 4
Description of the conditions for production of the composition in the laboratory

| | | Heating | | Cooling | |
|---|---|---|---|---|---|
| | ° Brix | temperature | Vacuum | temperature | Centrifugation |
| Crystallization | supersaturation | (° C.) | (po Hg) | (° C.) | mode tested |
| Thermal | 83 | 76.4-90 | 17-22 | 72 | Strong: 2 times |
| Cooling | 78 | 75.1 | 21 | 39.6 | 15 min/5000 rpm |
| | | | | | Moderate: |
| | | | | | 1 min/200 rpm |
| | | | | | then 5 min/1500 |
| | | | | | rpm |

2.3. Production of Syrup in Pilot Plant and on Large Scale

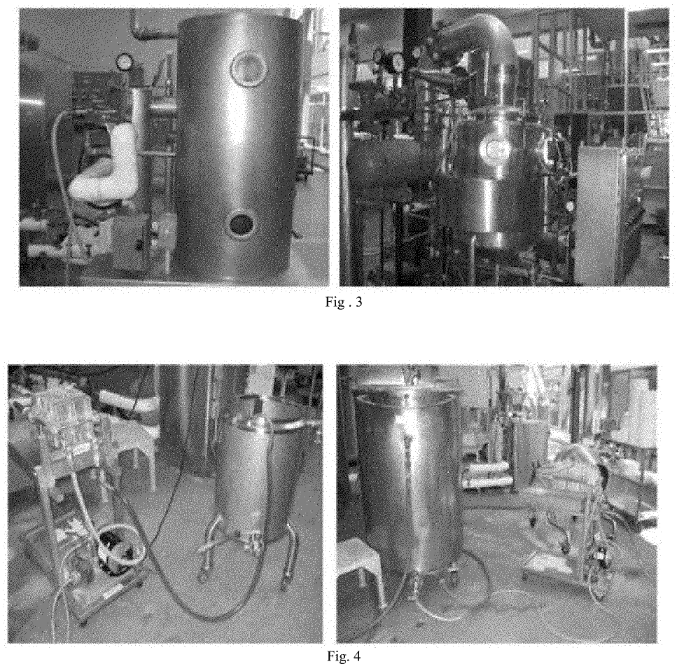

The kettles of concentrates 2 and 3 were thawed out at 4° C. for 24 h, then transferred to a tub of tepid water until fully thawed. These concentrates were transformed into non-caramelized maple syrup in a small vacuum evaporator (Anhydro, SPX, Denmark) (FIG. 3) on the pilot plant scale, then on a plate evaporator (APV junior, Crepaco, Denmark) (FIG. 3) on the semi-industrial scale. All of the syrups produced were filtered with the aid of a plate filter press (10 plates) with or without diatomaceous earth, as the case may be (FIG. 4). The conditions for production of non-caramelized syrups on the two scales tested are presented in Table 5.

TABLE 5
Description of the conditions for production of
non-caramelized syrup produced at the pilot plant

| | Heating | | |
|---|---|---|---|
| | temperature | Vacuum applied | |
| Evaporator used | (° C.) | (po Hg) | Method of filtration |
| Anhydro | 49 | 16 | Plate filter, 5 plates |
| APV | 42 | 25 | Plate filter, 8 plates |

2.4. Production of the Composition in the Factory

In a pilot plant, two types of equipment were used for the production of maple composition starting from non-caramelized syrup, either a small pilot crystallizer with a capacity of 20 L (Groen, TDC/2/RA-20, USA) on the pilot plant scale, or a large crystallizer with a capacity of 200 L (Goavec S.A, France) for the production of composition on the semi-industrial scale (FIG. 5). This equipment makes possible a supersaturation of the syrup and an initiating of the crystallization by an evaporation under vacuum. The equipment has a double-wall jacket which allows for heating the syrup by the circulation of steam or hot water. This jacket can also be used to cool down the cooked mass by circulating cold water in it. The equipment is outfitted with a mixer to ensure the homogeneity of the solution during the crystallization process. In all instances, the syrup at 66° Brix was heated up to supersaturation, at a ° Brix varying between 78 and 85%, and then cooled down between 37 and 72° C. according to the crystallization method used.

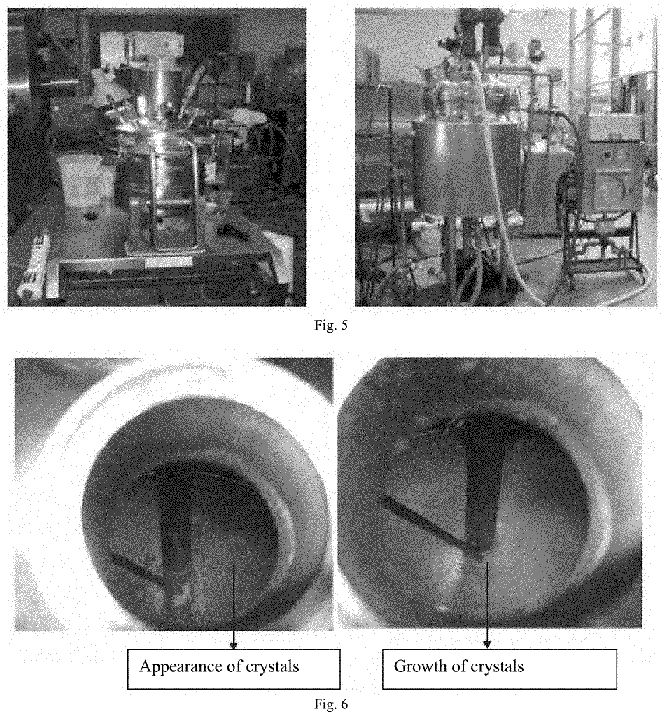

The thermal crystallization was carried out by increasing the ° Brix of the non-caramelized syrup up to the supersaturation in sugar. Upon the appearance of a sufficient quantity of crystals in the cooked mass, the vacuum was removed, and then the temperature of the solution was reduced down to 70° C. over the course of 1 to 1.5 hours (FIG. 6). The crystals were then separated by centrifugation. The supersaturation by cooling was done by increasing the ° Brix of the solution until nuclei of sugar crystals appeared, and then the solution was gradually cooled down to 40° C. over the course of 4 to 17 hours. This lowering of the temperature makes it possible to maintain the supersaturation of the solution and the crystallization at a less elevated temperature.

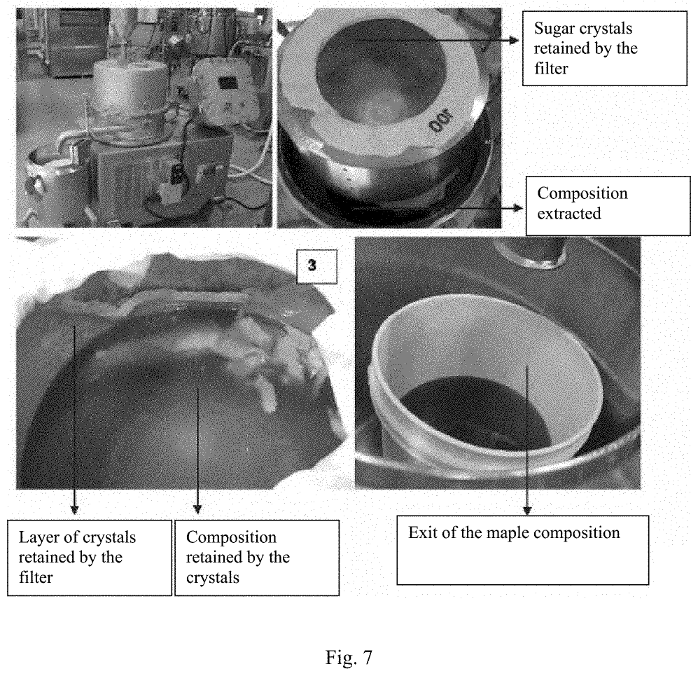

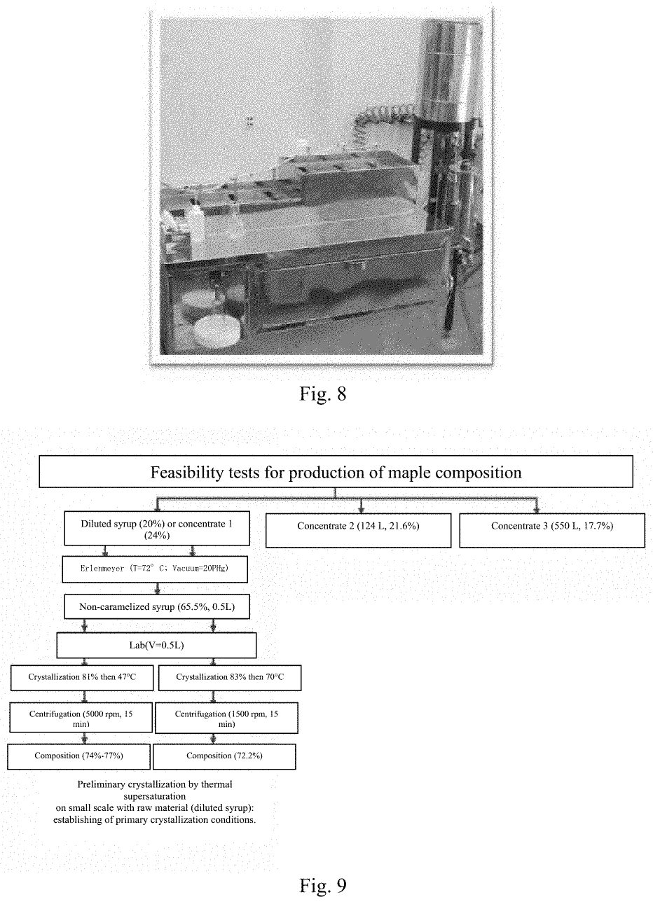

The centrifugation of the cooked mass was performed on a basket centrifuge (Western states, USA) outfitted with filters of size varying between 0.25 and 100 μm. The efficacy of the centrifugation depends altogether on the size of the filter used, the volume of cooked mass being centrifuged, and the size of the sugar crystals. Different filters were tested out, since they became clogged when the size of the crystals obtained was close to that of the filter used, as illustrated in photo 3 of FIG. 7.

In certain instances, demineralized water was added to the cooked mass, either during its cooling or prior to its centrifugation, in order to decrease its viscosity and cause the fine sugar crystals to melt. Many modalities of centrifugation were tested out, in order to separate the composition from the crystals with the available filters. First of all, the centrifugation went better when processing a volume of less than one liter at a time. Next, the distribution of the cooked mass on the filter was assured by feeding the centrifuge at low speed (200 rpm) over the course of one minute. The speed of the centrifuge is increased to different high levels. The conditions for production of the compositions 1 and 2 on the pilot plant and semi-industrial scale are presented in Table 6.

TABLE 6
Description of the conditions for production of the composition
at a pilot plant according to the two methods tested

| | | Heating | Vacuum | Cooling | | |
|---|---|---|---|---|---|---|
| | ° Brix | temperature | applied | Temperature | Time | |
| Scale | supersaturation | (° C.) | (po Hg) | (° C.) | (h) | Centrifugation |
| Pilot | 82-85 | 74.5 | 19-20 | 70 | 1.0 to 1.5 | 2000 to 2500 |
| plant | | | | | | rpm, 40 min |
| Pilot | 78 | 66-75 | 19-20 | 41 | 4 | |
| plant | | | | | | |
| Large | 80 | 79 | 19 | 37 | 17.0 | 1800 rpm; 15 |
| scale | | | | | | min |

The yield of composition 1 (large scale) varies from 30 to 33% of the volume of non-caramelized syrup. This composition underwent a second phase of crystallization (composition 2) on the pilot scale, for a yield of around 22.4% of the volume of composition 1. These yields would likely be higher if a specific centrifuge were used, one designed for the separation of the sugar crystals. These yields were largely affected by the success of separating the crystals during the centrifugation. A subsequent study is planned to optimize the crystallization and improve the performance of the centrifugation.

2.5. Production of Traditional (Caramelized) Syrup

Volumes of sap concentrate (concentrate 3) and compositions 1 and 2 produced from this same concentrate were used to produce maple syrup according to the method used to produce a traditional maple syrup. These syrups were produced on a pilot mini-evaporator available at the ACER Center. The sap concentrate was thawed out for the course of 24 h in a thawing system available at the ACER Center. It was then pre-filtered with the aid of a maple pre-filter #7 in order to eliminate the coarse particles which it might contain. The composition being much more concentrated and thawing out more quickly, it was thawed in a refrigerator at 4° C. overnight. It was then diluted with demineralized water until reaching the same ° Brix as the concentrate (22° Brix). The solution was homogenized with the aid of a compressed air agitator.

Each solution was transferred to the miniature electrical evaporator available at the ACER Center (Figure-8). This pilot evaporator is composed of three creased pans and three flat-bottom pans. It works on the same physical principle as the industrial evaporators for maple sap, or by a height difference, and it has control and data acquisition systems for different process parameters (preheating temperature, liquid height, heating temperature, liquid temperature, feed rate). The maple syrups made from the concentrate and the composition were produced under the same heating conditions, prior to being filtered under pressure with the aid of a vertical plate filter press with diatomaceous earth.

3. Experimental Protocol

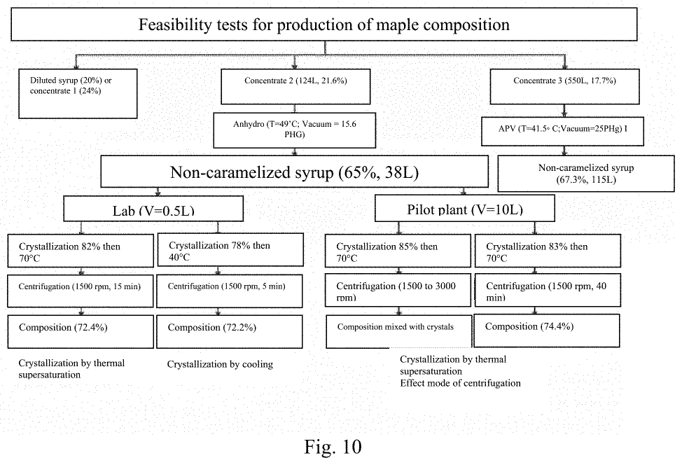

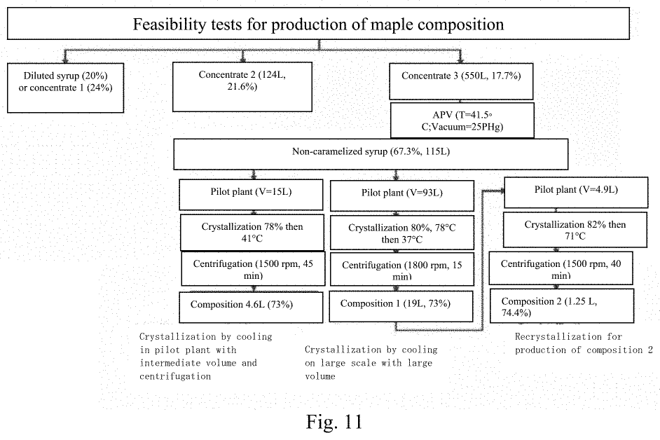

The experimental protocol was designed for preliminary tests and laboratory tests, as well as validation tests in an experimental plant on two scales (pilot plant and large scale). During the course of the tests, it was adjusted depending on the results obtained. The plans for the different tests carried out on the different scales are presented in FIGS. 9, 10 and 11.

4. Sampling Plan

Samples of concentrates, non-caramelized syrups, composition 1 and composition 2 were taken according to the test being performed. During the crystallization of the syrup, if the equipment used allowed one to recover the pure condensate independently of the cold water, the vapor condensates were removed. These samples were rapidly frozen for later assaying at the laboratory of the ACER Center. The purpose of the assays was to give a picture of the chemical composition of the different products and by-products obtained in the tests performed. This involved determining the chemical composition (content of sugar, minerals, and total polyphenols), the physico-chemical properties (pH, ° Brix, electrical conductivity), the sensory properties (flavor and color), the profile of volatile compounds (aroma) and the biological properties (antioxidant activity).

The color of the products was determined by measuring their transmission in light of 560 nm. Their flavor was evaluated by the maple syrup classifiers of the Acer inspection division of the ACER Center. Three inspectors tasted each of the samples blindfolded to assign them a taste grade and evaluate the presence of flavor defects, then decide by consensus on the final grade to be given them.

The profiles of volatile compounds in the composition, the condensates, and the maple syrups produced in this project were determined by GC/MS after SPME extraction SPME in headspace mode (Sabik et al., 2012). The fiber used for these tests is a fiber DVB-CAR-PDMS. The antioxidant activity was measured by the ORAC method and expressed in (1 TE Eq., μM), which means mol equivalent of Trolox per liter. The determination of the profile of mineral ions and the measurement of the antioxidant activity of certain fractions were done by outside laboratories. A summary of the samples taken and their assays is presented in Table 7.

TABLE 7
Summary of the assays performed as a function of the sampled product

| | Assays performed Number | | | | | | | | | |
|---|---|---|---|---|---|---|---|---|---|---|
| | | | | | | | Light | | | |
| | | | Electrical | Sugar | Mineral | Total | Transmission | Aroma | Sensory | Antioxidant |
| Product | Brix- | pH | Conductivity | Profile | Profile | phenols | (%) | profile | assay | activity |
| Diluted syrup | ✓ | ✓ | ✓ | ✓ | ✓ | ✓ | ✓ | x | x | x |
| or concentrate | 9 | 9 | 9 | 3 | 3 | 3 | 2 | | | |
| Noncaramelized | ✓ | ✓ | ✓ | ✓ | ✓ | ✓ | ✓ | ✓ | x | ✓ |
| syrup | 7 | 7 | 7 | 2 | 2 | 4 | 7 | 1 | | 1 |
| Composition | ✓ | ✓ | ✓ | ✓ | ✓ | ✓ | ✓ | ✓ | x | ✓ |
| 1 and 2 | 9 | 9 | 9 | 3 | 3 | 5 | 8 | 2 | | 2 |
| Caramelized | ✓ | ✓ | ✓ | ✓ | ✓ | ✓ | ✓ | ✓ | ✓ | ✓ |
| syrup | 2 | 2 | 2 | 2 | 2 | 2 | 2 | 2 | 2 | 2 |
| Condensate | x | x | x | x | X | x | x | ✓ | x | x |
| 1, 2, and 3 | | | | | | | | 3 | | |
| Total number | 27 | 27 | 27 | 10 | 10 | 14 | 19 | 8 | 2 | 5 |
| of assays | | | | | | | | | | |

5, Raw Material

The mean values of the physico-chemical characteristics and of the composition of the three lots of concentrates used in this project are presented in Table 8. The variations show that the different lots of concentrates have comparable levels of ° Brix, pH and electrical conductivity. They have low contents of invert sugars (glucose and fructose), less than 0.2%. The mean content of saccharose is 19.13%, which corresponds to a purity of 88% saccharose as compared to the total solids (° Brix).

TABLE 8
Physico-chemical characteristics and mean
sugar content of the concentrates used

| | | | Std. | | |
|---|---|---|---|---|---|
| Parameter | | Mean | deviation | Min | Max |
| Physico-chemical | Brix (%) | 21.7 | 2.0 | 18.9 | 23.6 |
| characteristics | Electrical | 2305 | 148 | 2180 | 2470 |
| | conductivity | | | | |
| | (μS/cm) | | | | |
| | pH | 7.41 | 0.42 | 6.94 | 7.94 |
| Sugar content | Saccharose | 19.13 | 2.43 | 17.41 | 20.85 |
| | (%) | | | | |
| | Glucose (%) | 0.08 | 0.07 | 0.04 | 0.13 |
| | Fructose (%) | 0.05 | 0.04 | 0.02 | 0.07 |

The concentrations of the principal mineral ions found in the concentrates used are presented in Table 9.

TABLE 9
Content of minerals found in the concentrate used

| Minerals | K | Ca | Mg | Mn | P | Zn | Al | Na |
|---|---|---|---|---|---|---|---|---|
| Content (mg/kg) | 911 | 725 | 68.8 | 40.7 | 10 | 2.1 | 1.15 | 0.80 |

The data show that potassium (K), calcium (Ca), magnesium (Mg) and manganese (Mn) are the minerals most present in the concentrates used. Phosphorus (P), zinc (Zn), aluminum (Al) and sodium (Na) are present in lower concentration. Negligible quantities of copper (Cu), iron (Fe) and cobalt (Co) were detected. The totality of the data obtained shows that the concentrates used in this study present the typical characteristics of a maple sap concentrate. This profile allows one to track the variation in the content of these mineral ions in the composition and the derived products.

Fruit juice, fruit juice concentrate, vegetable juice, and/or vegetable juice concentrate may also be used as raw material for the methods of this application.

For example, the fruit juice may be blueberry juice. Blueberry juice typically has a caloric value of 45 calories per 100 g of juice, coming from the sugar, which is equivalent to a sugar concentration of 11.3 g per 100 g of juice, and thus 11.3° Brix. The caloric value of sugar is 398 calories per 100 g of sugar.

6. Non-Caramelized Syrup

The mean characteristics of the non-caramelized syrups produced under vacuum from sap concentrates on the laboratory scale and pilot plant scale are presented in Table 10. These characteristics are comparable to the characteristics of a standard maple syrup (FPAQ, 2014, Van den Berg et al 2015). All the syrups have comparable levels of ° Brix, pH, and electrical conductivity. The mean content of saccharose in these non-caramelized syrups is 62.9%, which corresponds to a purity of 94% saccharose as compared to the total solids (°Brix).

Consequently, the transformation of the concentrate into non-caramelized syrup makes it possible to improve the purity of the saccharose and consequently helps in the crystallization. The concentration of total polyphenols in the syrups produced under vacuum depends on their concentration in the starting concentrate. The polyphenols are always concentrated by the same concentration factor of ° Brix between the concentrate and the syrup.

TABLE 10
Mean characteristics of the syrups produced in the laboratory,
on the pilot plant and the semi-industrial scale

| | | | Std. | | |
|---|---|---|---|---|---|
| Parameter | | Mean | deviation | Min | Max |
| Physico- | Brix (%) | 66.6 | 1.8 | 64.6 | 68.2 |
| chemical | Electrical | 251 | 38 | 214 | 297 |
| characteristics | conductivity | | | | |
| | (μS/cm) | | | | |
| | pH | 8.0 | 0.23 | 7.7 | 8.3 |
| | Transmittance | 41 | 37 | 11.9 | 89.2 |
| | (%) | | | | |
| Sugar content | Saccharose (%) | 62.89 | 0.93 | 62.24 | 63.55 |
| | Glucose (%) | 0.26 | 0.23 | 0.10 | 0.42 |
| | Fructose (%) | 0.14 | 0.12 | 0.05 | 0.23 |
| Polyphenols | Gallic acid | 260.3 | N.A | N.A | N.A |
| | equivalent | | | | |
| | (ppm) | | | | |
| Antioxidant | TE Eq. | 5432 | N.D. | N.D. | N.D. |
| activity | concentration, | | | | |
| | μM | | | | |

Important variations (min vs. max) are observed for the transmittance of the syrups produced on the different scales. The transmittance of the syrup produced on the semi-industrial scale was much lower (12%) than that of the syrup produced on the pilot plant scale (51%). Consequently, the non-caramelized syrup produced on the semi-industrial scale was much darker. It is possible that this difference results from a degradation in the quality of the concentrates during the long duration of the thawing of the large 20 L kettles containing these concentrates or is somehow connected to the type of heating in the two kinds of equipment used. The non-caramelized syrup has an antioxidant capacity close to that of apple juice (4140 TE Eq., μM) and less than that of blueberry juice (23590 TE Eq., μM) (Haytowitz et Bhagwat, 2010).

7. Maple Composition

Different modalities of crystallization and separation of the sugar crystals were tested out for the production of a composition from non-caramelized syrup on the different production scales. The effects of the principal modalities investigated are presented in the next sections.

7.1. Effect of the Crystallization Method

7.1.1. Physico-Chemical Characteristics

The two methods of crystallization, using thermal supersaturation and using cooling, were tested out for the production of a composition on the three scales (laboratory, pilot plant and large scale). The principal physico-chemical characteristics of the compositions produced according to the two methods are presented in Table 11.

The compositions produced by thermal supersaturation and cooling are quite similar at the level of the ° Brix and the pH. However, there are differences at the level of the electrical conductivity and the light transmission of the samples. On the laboratory scale, the composition produced by thermal supersaturation presents an elevated transmission and a low conductivity. This result might be explained by the addition of a small volume of water to aid in the separation of the crystals by centrifugation in the laboratory. From a general standpoint, these two parameters vary a bit according to the method of crystallization and the scale of production used.

TABLE 11
Physico-chemical characteristics of the compositions
produced on the different scales according to
the two principal methods of crystallization

| | Physico-chemical characteristics | | | |
|---|---|---|---|---|
| | | Electrical | | |
| Method of crystallization | Brix | conductivity | | Transmission |
| and scale of production | (%) | (μS/cm) | pH | (%) |
| Lab/thermal | 71.9 | 131 | 8.30 | 42.1 |
| Lab/cooling | 69.4 | 244 | 8.36 | 3.5 |
| Pilot plant/thermal | 68.9 | 287 | 8.34 | 0.2 |
| Pilot plant/cooling | 69.4 | 282 | 10.23 | 0.4 |
| Semi-industrial/cooling | 70.1 | 254 | 8.56 | 0.4 |
| Pilot plant/cooling 2 | 72.9 | 324 | 8.57 | 0.0 |

Cooling 2 means the second crystallization for production of composition 2.

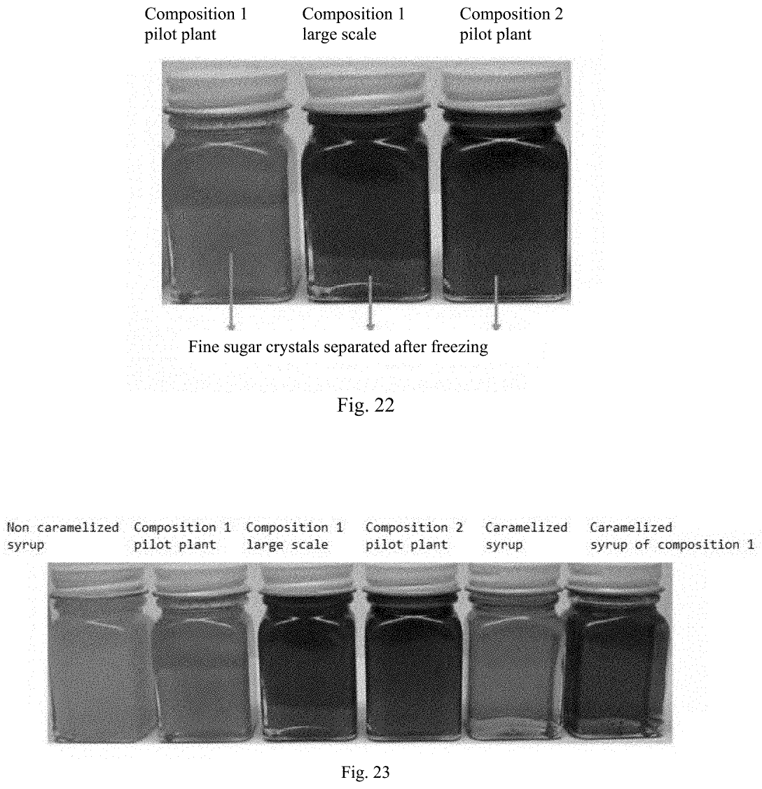

The differences appear to be more connected with the efficiency of separation of the sugar crystals by centrifugation. While the obtained composition is richer in fine sugar crystals, these may pass through the meshes of the filter used and deflect the rays of light, causing a lower transmission (FIG. 22).

In fact, the tests have shown that the crystallization of the sugar by cooling seems to be more appropriate, but that it produces much finer crystals. The limited number of tests did not allow us to optimize the time for increase in size of the crystals formed during the crystallization by supersaturation or by cooling. It would be important to investigate this point in order to improve the separation during the centrifugation, which would make the resulting composition brighter in color. As for the composition 2, produced by a second phase of crystallization, as compared to composition 1 obtained on a large scale, the two compositions have similar physico-chemical characteristics, except for the electrical conductivity, which is 1.3 times higher in composition 2.

7.1.2. Content of Polyphenols

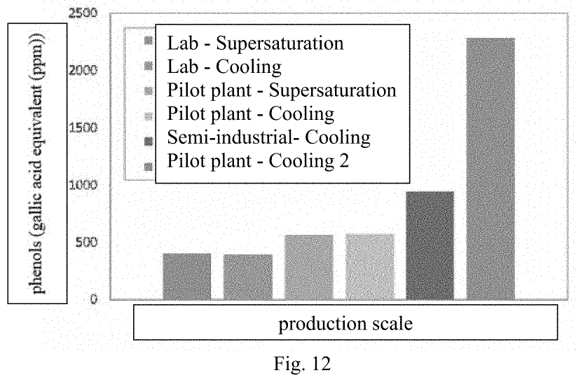

The content of total polyphenols in the compositions produced on the different scales is presented by FIG. 12. The results show that the concentration of polyphenols is similar in the compositions produced by the two methods of crystallization for the two laboratory tests and the two tests on a pilot plant scale. Thereafter, the content increases for the composition produced on the semi-industrial scale, to be once more raised in the composition 2. The concentration of polyphenols of the composition appears to have a tendency to increase with the scale of production. This increase is surely connected with the difference in the length of time of crystallization as a function of the volume processed.

7.1.3. Content of Minerals

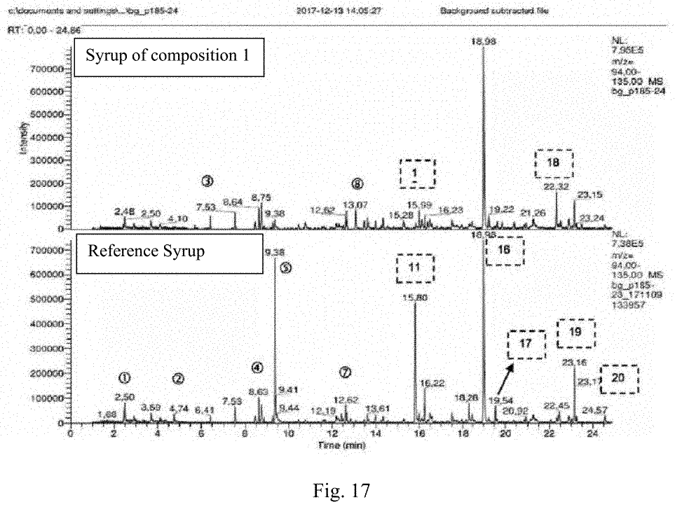

The contents of principal mineral ions in the compositions produced at the different scales that were tested are presented in FIG. 17. In general, one finds that potassium (K), calcium (Ca), magnesium (Mg) and manganese (Mn) are present in larger quantity. One also finds non-negligible quantities of phosphorus (P), sodium (Na) and zinc (Zn). In a lower proportion, one finds aluminum (Al), boron (B), copper (Cu), iron (Fe) and nickel (Ni).

If one compares the effect of crystallization by thermal supersaturation vs. that by cooling, one finds that the compositions produced by cooling on the laboratory and pilot plant scale have slightly higher contents. The most important mean differences are at the level of the content of calcium (Ca) (2.6 times higher), followed by those of manganese (Mn) and zinc (Zn) (1.3 times higher). The contents of aluminum (Al), copper (Cu) and iron (Fe) are lower by nearly 0.6 times. The other minerals are similar between the two types of crystallization. The total content of mineral ions in the composition produced by cooling is 1.3 times higher than that produced by thermal supersaturation. It thus appears that a portion of the minerals is precipitated in the sugar crystals during the crystallization by thermal supersaturation. Consequently, crystallization by cooling allows us to maintain more mineral ions in the composition produced.

Next, the contents of mineral ions in the compositions produced by cooling were compared on the pilot plant scale and the semi-industrial scale. The composition produced on the semi-industrial scale is richer in certain mineral ions such as iron (Fe) (6.9 times), copper (Cu) (5.7 times), phosphorus (P) (3.3 times) and manganese (Mn) (2.6 times). This increase is probably connected to both the longer time of crystallization and the smaller volume of centrifugation.

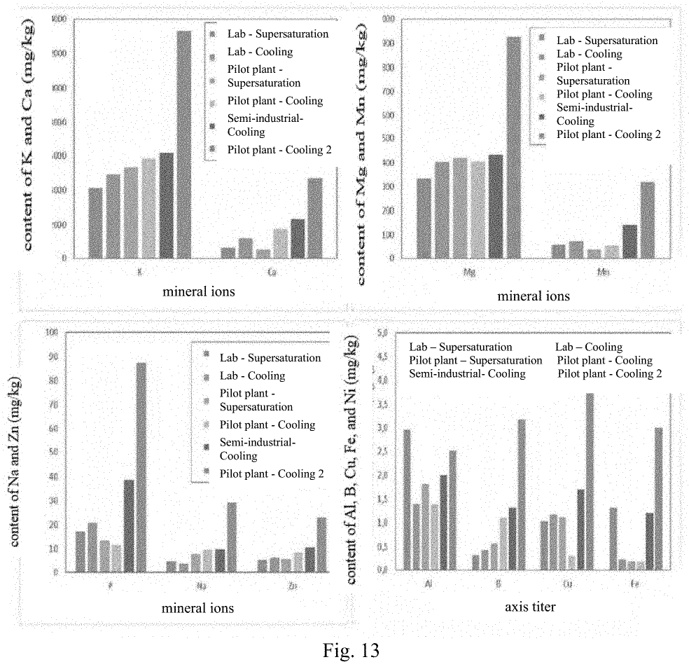

Moreover, the second crystallization by cooling, used for the production of composition 2, made it possible to increase the content of all the minerals by 2 to 3 times, as shown in FIG. 13. Consequently, the total content of the mineral ions in composition 2 is 2.1 times higher than in composition 1.

According to the results obtained, it is possible to deduce the following major trends:

The compositions produced by the two methods of crystallization have comparable physico-chemical characteristics.

The method of crystallization by cooling allows us to retain more divalent mineral ions such as calcium, manganese and zinc in the composition of maple, fruits and vegetables than the method of thermal supersaturation.

The content of polyphenols and minerals in the composition is improved with the scale of production.

The second crystallization (composition 2) makes it possible to further increase the concentration of polyphenols and that of all the minerals.

7.2. Effect of the Type of Composition

7.2.1. Sugar Content

The sugar content in the obtained compositions as compared to the non-caramelized syrup is presented in Table 12.

TABLE 12
Sugar content in the non-caramelized syrup and the compositions
obtained by cooling on the pilot plant and semi-industrial scale

| | | | | | Nonsugar |
|---|---|---|---|---|---|
| | | Sugar (%) | | | compounds |
| Production scale | Brix (%) | Saccharose | Glucose | Fructose | (%) |
| Non-caramelized syrup | 68.1 | 63.55 | 0.42 | 0.23 | 3.88 |
| Semi-industrial/composition 1 | 70.1 | 64.22 | 0.49 | 0.20 | 5.19 |
| Pilot plant/composition 2 | 72.9 | 60.04 | 0.99 | 0.38 | 11.49 |

It is possible to confirm that the content of saccharose, glucose and fructose in the composition 1 has not really changed as compared to the non-caramelized syrup. On the other hand, the second phase of crystallization has brought these values to a level of almost 2 times higher than in composition 1, while the saccharose has slightly diminished. Comparing the total sugars with the ° Brix of the composition, it appears that the content of nonsugar compounds increases by 2.2 times in composition 2, whereas it increased only 1.3 times in composition 1 as compared to the non-caramelized syrup. The content of saccharose has decreased further in composition 2, resulting in a drop in its purity down to 82%. These results show that the second crystallization makes it possible to extract more sugars than the first crystallization.

7.2.2. Profile of Volatile Compounds

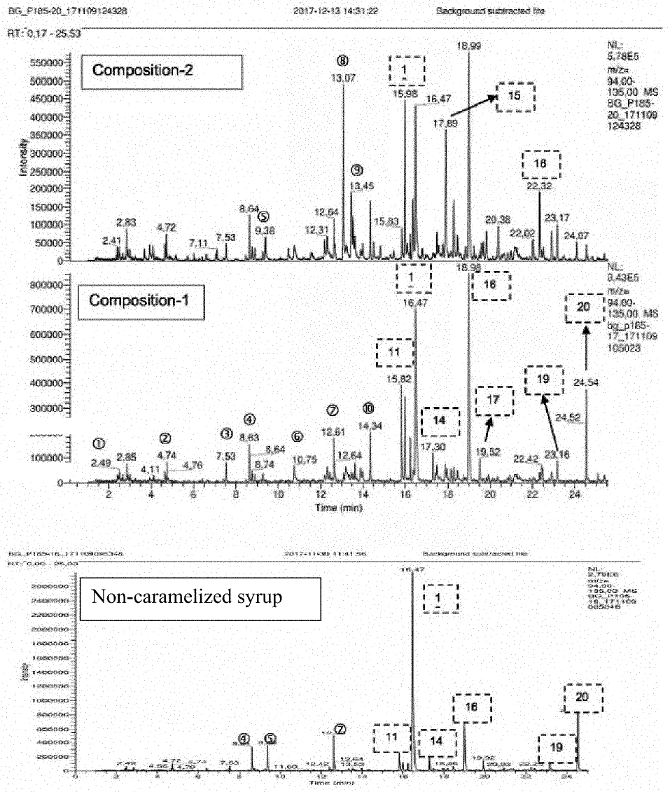

The profiles of volatile compounds detected in the two compositions produced by the method of crystallization by cooling are presented in FIG. 14. The peaks corresponding to the principal twenty volatile compounds detected in the profile of the maple composition have been identified by their retention time. The variation in the area of these peaks lets us trace the evolution of the concentration of the corresponding compounds in the different products obtained.

The two principal compounds present in the non-caramelized syrup are the peak 13 and the peak 16. The area of the peak corresponding to the compound 13 is 4 times that of the compound 16. By comparing the profile of the non-caramelized syrup and that of composition 1, we find a sharp decrease in the concentration of the principal compound (13) of 70%. Likewise, a large decrease has been registered for the compounds 7, 14 and 20. On the other hand, the contents of compounds 16 and 19 remain similar to the non-caramelized syrup, whereas the area of the peaks corresponding to the compounds 11 and 12 has increased by 2.2 times on average. An accentuation of the peaks of compounds 6, 10 and 17 has also been noticed in the profile of composition 1. Consequently, the area of the peaks corresponding to compounds 13 and 16 becomes similar in composition 1, whereas compound 16 is much less in the non-caramelized syrup, as mentioned above. This change in ratio as compared to the non-caramelized syrup may affect the taste perception of these two products.

Variations are also observed in the contents of volatile compounds between composition 1 and composition 2. There is a decrease in the area of the peaks corresponding to the two principal compounds (13 and 16) in composition 2 by nearly 1.7 times. There is a virtual disappearance of two compounds (11 and 20). On the other hand, there is a sharp increase in the peaks of the compounds 1, 2, 3 and 5. Other compounds such as 8, 9, 15 and 18 have a slight proportion in the aroma profile of composition 1, but occupy a strong proportion in composition 2. The contents of compounds 4, 12 and 19 remain similar in the two compositions. The area of the peak corresponding to compound 13 becomes less than that of compound 16 in composition 2.

Consequently, there is a sharp change in the proportion of the peaks of the major compounds in the profile of composition 2. These results show that the preparation of composition 1 from the non-caramelized syrup does not allow us to concentrate all of the volatile compounds already present. A decrease in the proportion of the principal compound (13) detected in the non-caramelized syrup occurs during the preparation of composition 1 and composition 2. The second compound of importance (16) is affected mainly during the preparation of composition 2. The contents of compounds such as 8, 9 and 15 are accentuated between the non-caramelized syrup and composition 2. These modifications of the profile of these volatile compounds will affect the overall taste grade of composition 1 and composition 2.

8. Caramelized Syrups

8.1. Physico-Chemical Characteristics

The caramelized syrups produced from the maple concentrate and composition on the same pilot evaporator were compared to each other, as well as compared to the non-caramelized syrup produced under vacuum on the semi-industrial scale. The mean values of the macroscopic characteristics, the sugar contents, the content of polyphenols and the antioxidant activities of these syrups are presented in Table 13. First of all, the three syrups have a similar pH and Brix degree.

TABLE 13
Physico-chemical characteristics, chemical composition and antioxidant activity
of non-caramelized and caramelized syrups produced from sap concentrate

| | | | Caramelized | Syrup of |
|---|---|---|---|---|
| | | Non-caramelized | syrup of | caramelized |
| Parameter | | syrup | reference | composition |
| Macroscopic | Brix (%) | 68.1 | 66.8 | 65.7 |
| characterization | Conductivity | 220 | 251 | 512 |
| | (μS/cm) | | | |
| | pH | 7.82 | 7.91 | 8.06 |
| | Transmission (%) | 12.2 | 61.5 | 21.4 |
| Sugar content | Saccharose (%) | 63.55 | 63.68 | 59.62 |
| | Glucose (%) | 0.42 | 0.16 | 0.27 |
| | Fructose (%) | 0.23 | 0.09 | 0.14 |

First of all, if one compares the non-caramelized syrup with the caramelized reference syrup, one will find certain differences. The two syrups have comparable electrical conductivities. The slight difference observed is probably due to the elevated ° Brix of the non-caramelized syrup, since the conductivity decreases with increase in the ° Brix during the transformation of the concentrate into syrup. Consequently, it appears that the two syrups have similar contents of mineral ions. It also appears that the non-caramelized syrup is richer in invert sugars (glucose and fructose) by around 1.5 times. Moreover, the transmission of this syrup is 5 times lower than that of the caramelized syrup, making it a darker syrup, even through it was produced under vacuum at a lower temperature. It is possible that the syrup produced under vacuum contains fine aggregations of minerals that were not held back by filtration.

Next, if one compares the syrup of caramelized composition produced from a diluted composition with the caramelized reference syrup, one also finds some differences. The transmission of the syrup of the composition is 3 times less than that of the reference syrup, making it a darker syrup. On the other hand, the electrical conductivity and the contents of glucose and fructose in the syrup of the composition are higher, by 2 and 6 times, respectively. The elevated conductivity of the syrup of the composition results from the strong conductivity of the diluted composition as compared to the conductivity of the sap concentrate (Table 14). This information indicates a higher content of minerals in the syrup of the composition. Consequently, the preparation of caramelized syrup from the composition lets one obtain a syrup which is richer in minerals. These results will be detailed in the section dedicated to minerals.

TABLE 14
Physico-chemical characteristics of the raw materials
used for the production of caramelized syrup

| | | | | Polyphenols |
|---|---|---|---|---|
| | Brix | | Conductivity | (gallic acid eq., |
| Raw material used | (%) | pH | (μS/cm) | ppm) |
| Concentrate | 20.5 | 7.40 | 2430 | 89.8 |
| Diluted composition | 22.3 | 9.02 | 3350 | 253.8 |

8.2. Content of Polyphenols and Antioxidant Activities

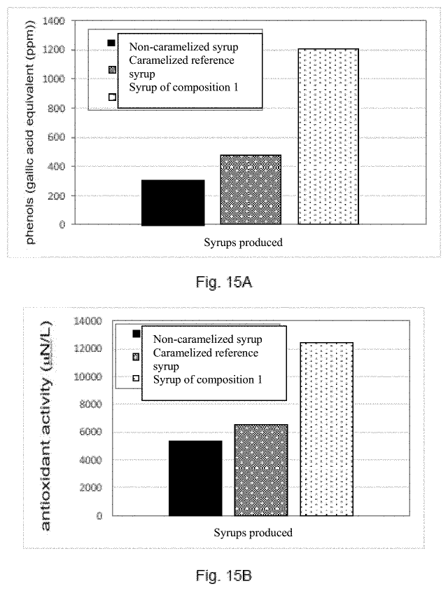

The content of polyphenols and the antioxidant capacity of the caramelized and non-caramelized syrups are presented in FIG. 15. The caramelized reference syrup has a more elevated antioxidant activity than that of the non-caramelized syrup by 1.6 times, since it is 1.5 times richer in polyphenols (FIG. 15).

In the same way, the syrup of the composition has a stronger antioxidant activity than the reference syrup by 2.5 times, since it is 1.9 times richer in polyphenols, as illustrated in FIG. 15. Consequently, the preparation of a syrup from the composition lets one obtain a syrup which is much richer in phenol and having a strong antioxidant activity.

The deviations obtained between the reference syrup and the syrup of the composition are probably connected with the difference in concentration of polyphenols in the corresponding raw material of each product. In fact, the concentration of polyphenols is elevated in the composition prior to dilution. The diluted composition used for the preparation of the syrup is thus 2.8 times richer in polyphenols than the sap concentrate used for the preparation of the reference syrup (Table 13). During the cooking of the two syrups, the polyphenols were concentrated by the same concentration factor.

8.3. Content of Minerals

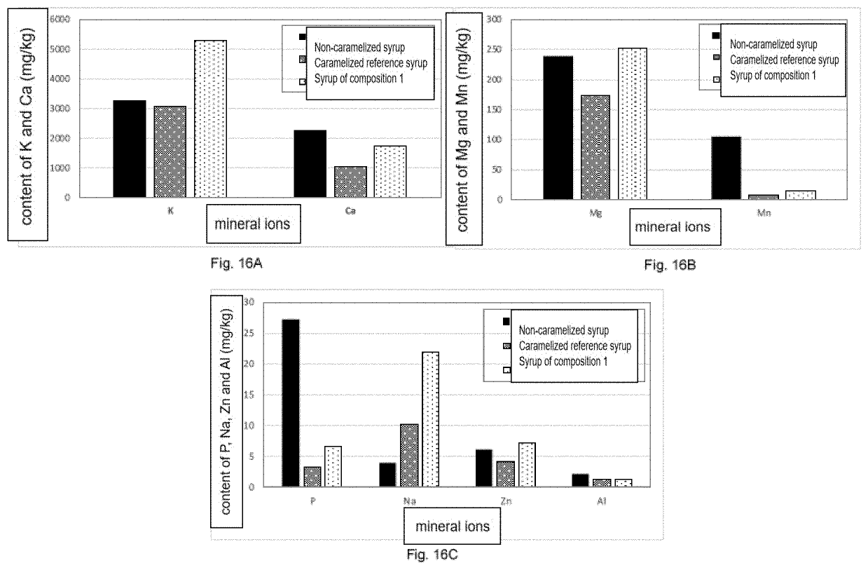

The principal minerals found in the caramelized syrups produced on the pilot evaporator and the non-caramelized one produced on the evaporator (APV) are presented in FIG. 16. The mineral ions most present are potassium (K), calcium (Ca) and magnesium (Mg). One also finds manganese (Mn), phosphorus (P), sodium (Na) and zinc (Zn). In smaller concentrations are found aluminum (Al), boron (B), iron (Fe) and nickel (Ni). Copper (Cu) is no longer found in the pilot syrups, whereas it was present in the non-caramelized concentrate, the compositions and the syrup. In the syrup of the caramelized composition, one finds small quantities of lead (Pb), cobalt (Co) and cadmium (Cd).

Several minerals have higher contents in the non-caramelized syrup as compared to the reference syrup. Calcium (Ca), boron (B), zinc (Zn) and aluminum (Al) all increase by 1.5 to 2.5 times, while sodium (Na) decreases by around 2.5 times. Those showing the greatest increase are manganese (Mn) (16.1 times), phosphorus (P) (8.5 times) and iron (Fe) (4.3 times).

The syrup of caramelized composition 1 has more elevated contents for the majority of the minerals as compared to the reference syrup. The contents of potassium (K), calcium (Ca), magnesium (Mg), phosphorus (P), sodium (Na) and zinc (Zn) are increased between 1.5 and 2.2 times in the syrup of the composition. The total content of the mineral ions in the syrup of the composition is increased by 1.7 times as compared to the reference syrup. These results show that the syrup of the composition is richer in mineral ions as compared to the reference syrup produced from the same starting concentrate.

Tables 15, 16, 17, 18, 19, and 20 are a summary of the different data collected in the tests presented in sections 6, 7 and 8.

TABLE 15
Physico-chemical characteristics, chemical composition and various characteristics
of the various concentrates, compositions and syrups produced from maple sap

| | | | Reference | Non- | | | | |
|---|---|---|---|---|---|---|---|---|
| | | | Caramelized | caramelized | | | Syrup of | Syrup of |
| Parameter | | Concentrate | syrup | syrup | Composition 1 | Composition 2 | composition 1 | composition 2 |
| Physico- | Brix (degree) | 20.5 | 66.8 | 68.1 | 70.1 | 72.9 | 65.7 | 72.9 |
| Chemical | Conductivity | 2430 | 251 | 220 | 254 | 324 | 512 | |
| Characteristics | (25° C., μS/cm) | | | | | | | |
| | pH | 7.40 | 7.91 | 7.82 | 8.56 | 8.57 | 8.06 | |
| | Transmittance (%) | | 61.50 | 12.15 | 0.40 | 0.00 | 21.35 | |
| Phenols | Concentration | 89.9 | 478.4 | 305.6 | 945.3 | 2282.4 | 1208.6 | 3143.5 |
| ppm (mg/kg) | (gallic acid | | | | | | | |
| | equivalent, ppm) | | | | | | | |
| Antioxidants | TE | | 6531.6 | 5431.9 | 11547.4 | 11300.2 | 12453.0 | |
| umol/L | Concentration | | | | | | | |
| | μM (μmole/L) | | | | | | | |
| Sugars | Sucrose | 19.13 | 63.68 | 63.55 | 64.22 | 60.04 | 59.62 | 60.04 |
| % (g/100 g) | Glucose | 0.08 | 0.16 | 0.42 | 0.49 | 0.99 | 0.27 | |
| | Fructose | 0.05 | 0.09 | 0.23 | 0.20 | 0.38 | 0.14 | |

TABLE 16
Physico-chemical characteristics, chemical composition and various characteristics
of the various concentrates, compositions and syrups produced from maple sap

| | | Caramelized | Non- | | | |
|---|---|---|---|---|---|---|
| | | syrup | caramelized | | | Syrup of |
| Minerals | Concentrate | (ref.) | syrup | Composition-1 | Composition-2 | composition 1 |
| K | 911.00 | 3042.00 | 3226.00 | 6137.00 | 13325.00 | 5283.00 |
| Ca | 725.00 | 1033.00 | 2260.00 | 2335.00 | 4702.00 | 1735.00 |
| Mg | 68.80 | 174.00 | 239.00 | 432.00 | 925.00 | 253.00 |
| Mn | 40.70 | 6.51 | 105.00 | 140.00 | 318.00 | 13.20 |
| P | 10.01 | 3.22 | 27.23 | 38.55 | 87.38 | 6.57 |
| Zn | 2.06 | 4.08 | 6.08 | 10.60 | 22.80 | 7.18 |
| Na | 0.80 | 10.10 | 3.97 | 10.00 | 29.20 | 22.00 |
| Al | 1.15 | 1.37 | 2.14 | 2.00 | 2.52 | 1.25 |
| B | 0.00 | 0.15 | 0.38 | 1.32 | 3.18 | 0.94 |
| Cu | 0.10 | 0.00 | 1.14 | 1.71 | 3.82 | 0.00 |
| Fe | 0.03 | 0.14 | 0.61 | 1.20 | 3.01 | 0.19 |
| Mo | 0.00 | 0.00 | 0.00 | 0.00 | 0.00 | 0.00 |
| Cd | 0.00 | 0.00 | 0.00 | 0.00 | 0.12 | 0.00 |
| Cr | 0.00 | 0.00 | 0.02 | 0.02 | 0.12 | 0.00 |
| Co | 0.03 | 0.00 | 0.00 | 0.00 | 0.07 | 0.02 |
| Pb | 0.00 | 0.00 | 0.00 | 0.12 | 0.09 | 0.22 |
| Ni | 0.00 | 0.00 | 0.00 | 0.32 | 1.31 | 0.33 |

TABLE 17
Calculation of the ratio of the concentration of different compounds
to the concentration of saccharose in the different products.

| | | | Caramelized | Non- | | | Syrup of | Syrup of |
|---|---|---|---|---|---|---|---|---|
| Unit | Ration/saccharose | Concentrate | syrup | Caramelized | Comp 1 | Comp 2 | Comp 1 | Comp 2 |
| mg/g sucrose | Polyphénols | 0.47 | 0.75 | 0.48 | 1.47 | 3.80 | 2.03 | 5.24 |
| mg/g sucrose | Potassium | 4.76 | 4.78 | 5.08 | 9.56 | 22.19 | 8.86 | |
| mg/g sucrose | Calcium | 3.79 | 1.62 | 3.56 | 3.64 | 7.83 | 2.91 | |
| mg/g sucrose | Mg | 0.36 | 0.27 | 0.38 | 0.67 | 1.54 | 0.42 | |
| mg/g sucrose | Mn | 0.21 | 0.01 | 0.17 | 0.22 | 0.53 | 0.02 | |
| mg/g sucrose | Phosphore | 0.05 | 0.01 | 0.04 | 0.06 | 0.15 | 0.01 | |
| mg/g sucrose | Sodium | 0.004 | 0.016 | 0.006 | 0.016 | 0.049 | 0.037 | |

| | | | | | | |
|---|---|---|---|---|---|---|
| μmole/g | Antioxidant | 102.6 | 85.5 | 179.8 | 188.2 | 208.9 |
| sucrose* | | | | | | |

TABLE 18
Calculation of the ratio of the concentration of different
elements to the concentration of saccharose

| | Content of | Content | Content | Content | Content | Content |
|---|---|---|---|---|---|---|
| | polyphenols | of P in | of Mg in | of Fe in | of Mn in | of Na in |
| | in mg/g of | mg/g of | mg/g of | mg/g of | mg/g of | mg/g of |
| Product | saccharose | saccharose | saccharose | saccharose | saccharose | saccharose |
| Concentrate | 0.47 | 0.05 | 0.36 | 0.00015 | 0.21 | 0.004 |
| (20 brix) | | | | | | |
| Non- | 0.48 | 0.04 | 0.38 | 0.00096 | 0.17 | 0.006 |
| caramelized | | | | | | |
| syrup | | | | | | |
| Reference | 0.75 | 0.01 | 0.27 | 0.00022 | 0.01 | 0.016 |
| (caramelized) | | | | | | |
| syrup | | | | | | |
| Composition 1 | 1.47 | 0.06 | 0.67 | 0.00187 | 0.22 | 0.016 |
| Composition 2 | 3.8 | 0.15 | 1.54 | 0.00501 | 0.53 | 0.049 |
| Syrup of | 2.03 | 0.01 | 0.42 | 0.00032 | 0.02 | 0.037 |
| composition 1 | | | | | | |

TABLE 19
Calculation of the ratio of the theoretical concentration
of polyphenols to the concentration of saccharose

| | Syrup of | | Syrup of |
|---|---|---|---|
| | composition 1 | Composition 2 | composition 2 |
| Polyphenols | 194.83 | 353.79 | 487.26 |
| Concentration | | | |
| (gallic acid | | | |
| equivalent, ppm) | | | |
| mg/kg | | | |

TABLE 20
Calculation of the level of production of polyphenol
during the evaporation (concentration)

| | Level of production |
|---|---|
| | of polyphenol |
| Caramelized syrup (reference) | 59.87% |
| Non-caramelized syrup | 2.33% |
| Syrup of composition 1 | 37.72% |
| Syrup of composition 2 (theoretical) | 37.72% |

TABLE 21
Gain in nutritional value with the processes described

| | | Polyphenol | K | Ca | Mg | Mn |
|---|---|---|---|---|---|---|
| Process | Product | (%) | (%) | (%) | (%) | (%) |
| Concentration | Non- | 2.33 | 6.62 | −6.14 | 4.59 | −22.32 |
| under vacuum | caramelized | | | | | |
| | syrup | | | | | |
| Concentration | Composition 1 | 213.26 | 100.70 | −4.05 | 87.07 | 2.48 |
| under vacuum | Composition 2 | 709.01 | 366.08 | 106.66 | 328.42 | 148.97 |
| and extraction | | | | | | |
| of sugar | | | | | | |
| Concentration | Syrup of | 331.44 | 86.10 | −23.20 | 18.01 | 89.59 |
| under | composition 1 | | | | | |
| vacuum, | Syrup of | 1014.20 | | | | |
| extraction of | composition 2 | | | | | |
| sugar and | | | | | | |
| caramelization | | | | | | |

8.4. Flavor and Profile of Volatile Compounds

The results of the sensory evaluation for the flavor of the two caramelized syrups produced on the miniature pilot evaporator are presented in Table-19. The results show that the two syrups have similar flavor scores ranging from checkmark to VR1 or VR4 with a note of caramel. Thus, the taste of the syrup produced from the diluted composition also has the same taste grades as the reference syrup. But this evaluation does not allow one to qualify the syrups in terms of the intensity of their taste.

TABLE 22
Flavor grade by consensus of the samples
of syrup produced on the pilot evaporator

| Syrup produced | Flavor grade | Description |
|---|---|---|
| Syrup of concentrate | ✓ and VR1-VR4 | caramel taste plus other |
| (Reference) | | tastes |
| Syrup of composition | ✓-Ok and VR1 | Sap, caramelized |

A comparison of the profile of the volatile compounds detected in each of these syrups lets us affirm that there are few differences between the concentration of principal volatile compounds (in terms of peak area) for the two syrups (FIG. 17).

First of all, it is possible to mention the disappearance of the peak of compound 13 from the two syrups, which was the principal compound in the non-caramelized syrup. Next, the area of the peaks of the second principal compound 16 is similar in the two syrups. Likewise, the peaks corresponding to the volatile compounds 4, 7 and 13 are identical. On the other hand, a sharp decrease in the area of the peaks of compounds 5 and 11 is visible for the syrup of the composition, whereas one finds a sharp increase in the peak of compound 12. These results indicate that the two syrups do not have exactly the same aroma profile, and that the syrup of the composition is not necessarily richer in volatile compounds than the reference syrup. Consequently, the preparation of the syrup of the composition does not provide an accentuation of the volatile compounds already present in the reference syrup. It is difficult at the time being to anticipate the impact of these changes in the aroma profile on the taste of these two syrups.

8.5. Condensate

Two condensates were recovered during the preparation of the composition by the two methods of crystallization at two levels of ° Brix: 82% for the thermal supersaturation and 78% for that of cooling. The two condensates have a mean pH of 8.25.

8.5.1 Profile of Volatile Compounds

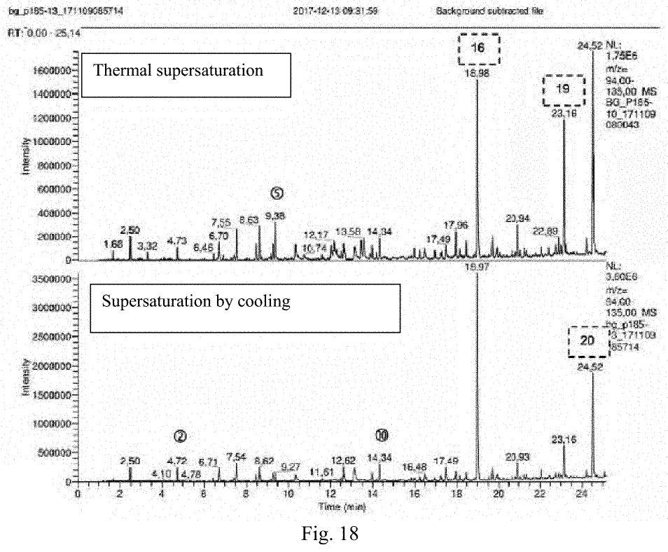

The profiles of volatile compounds detected in these two condensates are presented in FIG. 18. These profiles let us affirm that the majority of the peaks detected in the non-caramelized syrup are likewise detected in the two condensates. The area of the peaks of the majority of the compounds are similar in the two condensates. The condensate obtained by cooling contains on average more than 2.7 times of the compounds 4 and 16 than that obtained by thermal supersaturation.

The compound 13, which was the one most present in the non-caramelized syrup (FIG. 16), is found by only around 5% in the two condensates. Its content was also greatly diminished in composition 1. These results indicate the possibility that this compound was degraded into other volatile compounds during the crystallization, or that it escaped with the noncondensed vapor, since it was not recovered in the condensate.

However, the condensates are richer in compounds 16, 19 and 20. They contain 4 to 8 times more of them than the non-caramelized syrup, and 4 to 7 times more than the composition. The area of the peaks of these compounds was similar in the non-caramelized syrup and the composition, so that it is possible that a sizeable portion of these compounds was generated during the supersaturation.

These results show that the volatile compounds present in the non-caramelized syrup have been evaporated and entrained with the water vapor during the step of supersaturation.

9. Transformation Sequence of the Product

This phase involves performing an analysis of the effect of the transformation of the maple sap concentrate into the different products according to the production process of the composition. This analysis lets us discover the effect of the successive stages on the compounds and their properties of interest. A photo of different products obtained by the manufacturing process for the composition and these derivatives is presented in FIG. 23.

9.1. Content of Polyphenols and Antioxidant Properties

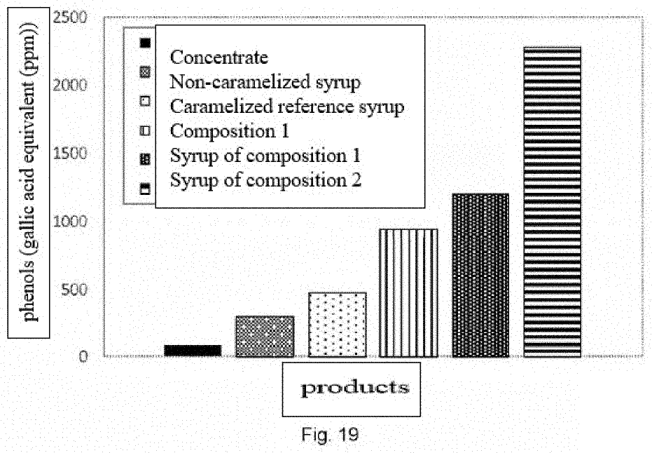

The content of polyphenols increases during the transformation of the sap concentrate into different products, reaching a maximum in the syrup of composition 2 (FIG. 19). Composition 1 and composition 2 contain respectively 10 and 25 times more polyphenols than the sap concentrate. It is possible to note that there are two main stages allowing a further increase in the content of polyphenols. The most important stage is the production of composition 1 from the non-caramelized syrup, since it concentrates the polyphenols by a factor of 3.1 times. The second stage is the production of composition 2 from composition 1, allowing an enrichment by a factor of 2.4 times.

The production of syrup from composition 1 enables an increasing of the phenol content by a factor of 1.3. Consequently, there are not many advantages between the production of composition 1 and the syrup of the composition. The production of composition 2 is more advantageous in terms of content of polyphenols than the syrup of the composition. On the other hand, the latter is more advantageous than the production of reference syrup. The production of syrup from composition 2 allows a further augmentation of the phenol content by a factor of 1.3 as compared to composition 2.

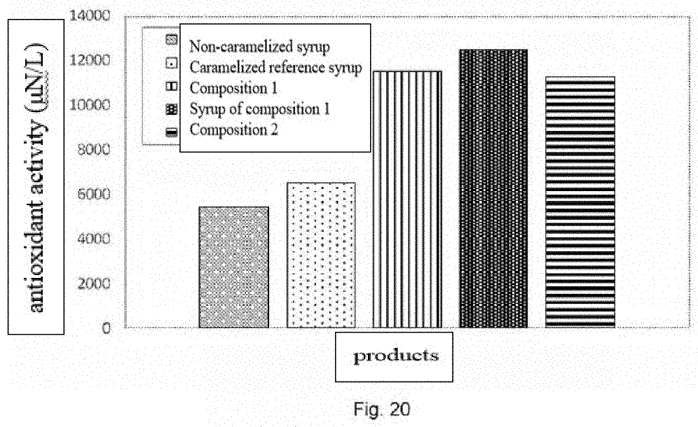

FIG. 20 likewise shows that the antioxidant activity increases more with the preparation of composition 1 by a factor of 2.1 as compared to the non-caramelized syrup. It remains quite similar between composition 1, composition 2, and the syrup of the composition. The production of composition 2 provides no improvement in the antioxidant activity of this product as compared to composition 1. However, this activity is augmented in the caramelized syrup by a factor of 1.2 as compared to the non-caramelized syrup. In the same fashion, the production of the syrup of the composition allows an increasing of this by a factor of 1.1 as compared to composition 1. Consequently, the caramelization does not provide a major improvement in the antioxidant activity. Composition 1 seems to be the first choice for its antioxidant capacity and in terms of production steps.

9.2. Content of Minerals

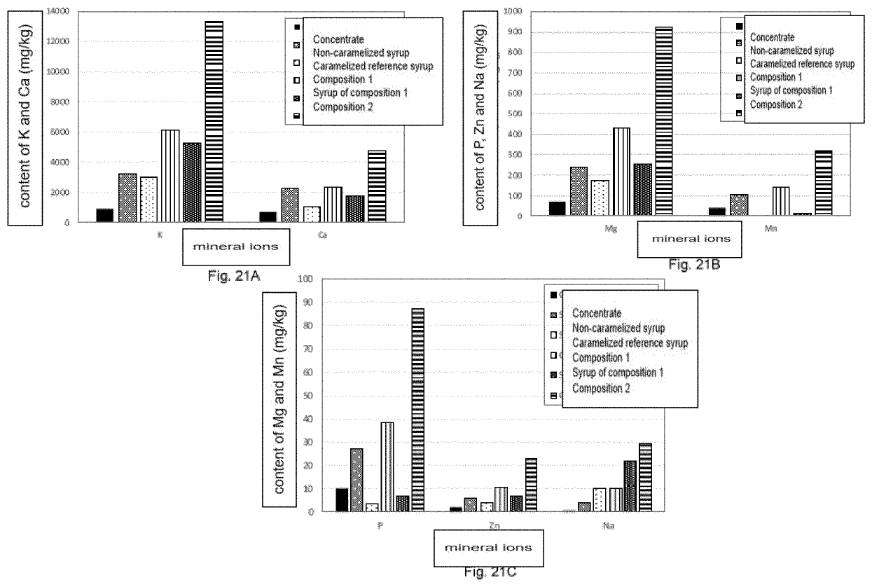

As for minerals, the two main stages for concentrating the minerals are the production of the non-caramelized syrup from the concentrate, followed by the production of composition 2 from composition 1. It is possible to affirm the following two distinct trends (FIG. 21).

The production of the composition appears to increase the content of the majority of the mineral ions, whereas the production of a caramelized syrup, from concentrate or from the composition, causes them to decrease instead. This trend is observed particularly for the divalent ions such as calcium (Ca), magnesium (Mg), manganese (Mn) and phosphorus (P). Composition 2 is the product which is richest in mineral ions, followed by composition 1 and the syrup of the composition, then the caramelized syrup. It appears that the syrup of the composition is less advantageous than composition 1. Moreover, this contains 2 times more total minerals than the caramelized syrup. The contents of manganese (Mn), phosphorus (P), boron (B) and iron (Fe) are 8 to 21 times higher in composition 1 than the caramelized syrup.

Summarizing, composition 2 wins out for its richness in polyphenols and minerals. On the other hand, composition 1 and the syrup of the composition are also products of choice depending on the interests of the different sectors of the target markets.

In conclusion, the following major trends may be deduced from the results obtained:

The compositions produced by the two methods of crystallization are comparable. The method of crystallization by cooling lets us obtain higher values in mineral ions, especially for the divalent ions. An increasing of the scale of production allows an increase in the content of polyphenols.

The production of the composition lets us obtain a richer product than the traditional syrup in polyphenols, minerals and antioxidant activity. Composition 2 is much richer in these compounds, except for the antioxidant activity, which is similar to that of composition 1.

The non-caramelized syrup has lower values than the reference syrup for the light transmission, the concentration of polyphenols, and the antioxidant activity. On the other hand, it is richer in glucose, fructose and mineral ions.

The syrup of the composition has higher values than the traditional syrup for the electrical conductivity, the contents of glucose, fructose, polyphenols, antioxidants, as well as the majority of minerals. These increases appear to be connected with the use of a composition already richer in these compounds for the production of this syrup. However, a portion of the minerals seem to have decreased instead during the production of the syrup of the composition as compared to the starting composition.

In terms of the sensory analysis, the two syrups (traditional and that of the composition) produced comparable taste. Thus, the syrup of the composition seems to be as good as the reference syrup.

The profile of the volatile compounds changes greatly as one proceeds along the production chain between the non-caramelized syrup and composition 2. The content of certain compounds diminishes, while for others it increases. These changes may affect the flavor perception of these products. But it is difficult at this stage of the study to define the links between the taste of these syrups and the changes registered in their profiles of volatile compounds.

Table 23 shows results obtained from compositions produced according to the present disclosure.

TABLE 23
Gain in nutritional values with our process

| | | Sugar | Polyphenol | Antioxidant | K | Ca | Mg | Mn |
|---|---|---|---|---|---|---|---|---|
| Concentration under vacuum | Non-caramelized syrup (SNC) | 0.00% | 2.33% | 0.00% | 6.62% | −6.14% | 4.59% | −22.32% |
| Concentration under vacuum, | Non-caramelized | 0.00% | 0.00% | 0.00% | 0.00% | 0.00% | 0.00% | 0.00% |
| sugar extraction | composition 1 | | | | | | | |
| | Non-caramelized | 0.00% | 213.26% | 0.00% | 100.70% | −4.05% | 87.07% | 2.48% |
| | composition 2 | 0.00% | 709.01% | 0.00% | 366.08% | 106.66% | 328.42% | 148.97% |
| Concentration under vacuum, | Syrup of composition 1 | 0.00% | 0.00% | 0.00% | 0.00% | 0.00% | 0.00% | 0.00% |
| sugar extraction, and | Syrup of composition 2 | 0.00% | 331.44% | 0.00% | 86.10% | −23.20% | 18.01% | −83.59% |
| caramelization | (theoretical) | 0.00% | 1014.20% | 0.00% | 0.00% | 0.00% | 0.00% | 0.00% |

10. Tests Performed on Various Juices

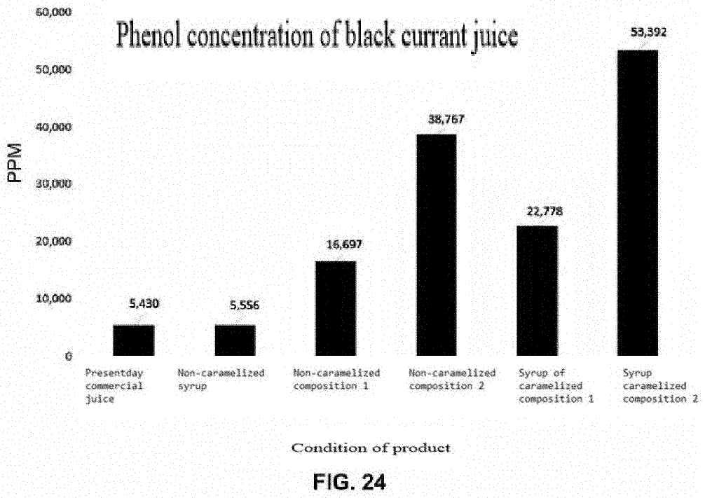

Tables 24, 25 and 26, as well as FIG. 24, show the results obtained from the use of various fruit juices. The juices were processed by the same methods as described above in regard to various products based on maple sap, maple concentrate, or various maple compositions. As previously mentioned, the same methods were used, only the starting product being different, i.e., different juices were used as the starting product during the tests of Tables 24, 25 and 26, as well as FIG. 24. The methods used were thus the same as that illustrated in FIG. 1, but the maple sap was replaced by juices. The results of these tables and this figure shows that these methods are polyvalent and that they can process various starting products containing sugar. In particular, in FIG. 24 one may see that the methods make it possible to concentrate around 3 to 10 times the content of polyphenols as compared to the starting juice. In fact, as compared to the starting black currant juice, the non-caramelized composition 1 was around 3 times more concentrated in polyphenols; the non-caramelized composition 2 was around 7.1 times more concentrated in polyphenols; the caramelized syrup of composition 1 was around 4.2 times more concentrated in polyphenols; and the caramelized syrup of composition 2 caramelized was around 9.9 times more concentrated in polyphenols.

TABLE 24
Present-day commercial juice

| | | | Antioxidant capacity | | | Data per nutritional value tables | | | |
|---|---|---|---|---|---|---|---|---|---|
| | Total polyphenols | | TEAC | DPPH | FRAP | Portion | Sugars | Calories | |
| | mg GAE/100 | ppm | umol TE/100 | umol TE/10 | umol TE/100 mL | mL | g | Cal | |
| Commercial juice | 336 | 3360 | 2800 | 1500 | 1800 | 250 | 34 | 160 | |
| pomegranate | | | | | | | | | |
| Commercial juice | 311 | 3110 | 500 | 600 | 400 | 236 | 30 | 150 | |
| pomegranate blueberry | | | | | | | | | |
| Commercial juice | 225 | 2250 | 400 | 300 | 200 | 237 | 35 | 140 | |
| concord grapes | | | | | | | | | |
| Commercial juice | 90 | 900 | 300 | 200 | 150 | 250 | 23 | 110 | |
| cranberry | | | | | | | | | |
| Commercial juice | 150 | 1500 | 300 | 140 | 135 | 250 | 23 | 110 | |
| orange | | | | | | | | | |
| Commercial juice | 511 | 5110 | 4260 | 2900 | 3280 | 240 | 23 | 120 | |
| aronia | | | | | | | | | |
| Commercial juice | 543 | 5430 | 4100 | 2750 | 3140 | 240 | 15 | 110 | |
| black currant | | | | | | | | | |
| | 7.8447694 | 7.8288 | | | | | | | |
| | | | | | | | | | 4.7 |

source: Abountiolas et Nascimento Nunes, 2018, Int. J. Food Sci. Technol, 53, 188

TABLE 25
Non-caramelized syrup (SNC) of juices with our process

| | | | | Antioxidant capacity | | | Data per nutritional value tables | | |
|---|---|---|---|---|---|---|---|---|---|
| | Total polyphenols | | | TEAC | DPPH | FRAP | Portion | Sugars | Calories |
| | mg GAE/100 | ppm | Brix du jus | umol TE/100 | umol TE/10 | umol TE/100 mL | mL | g | Cal |
| Commercial juice | 344 | 3438 | 11.5 | 2800 | 1500 | 1800 | 250 | 34 | 160 |
| pomegranate | | | | | | | | | |
| Commercial juice | 318 | 3183 | 11.5 | 500 | 600 | 400 | 236 | 30 | 150 |
| pomegranate blueberry | | | | | | | | | |
| Commercial juice | 230 | 2303 | 11.5 | 400 | 300 | 200 | 237 | 36 | 140 |
| concord grapes | | | | | | | | | |
| Commercial juice | 92 | 921 | 11.5 | 300 | 200 | 150 | 250 | 23 | 110 |
| cranberry | | | | | | | | | |
| Commercial juice | 154 | 2535 | 11.5 | 300 | 140 | 135 | 250 | 23 | 110 |
| orange | | | | | | | | | |
| Commercial juice | 523 | 5229 | 11.5 | 4260 | 2900 | 3280 | 240 | 23 | 120 |
| aronia | | | | | | | | | |
| Commercial juice | 556 | 5557 | 11.5 | 4100 | 2750 | 3140 | 240 | 15 | 110 |
| black currant | | | | | | | | | |

source: Abountiolas et Nascimento Nunes, 2018, Int. J. Food Sci. Technol, 53, 188

TABLE 26
Non-caramelized composition 1

| | | Antioxidant capacity | | | Data per nutritional value tables | | |
|---|---|---|---|---|---|---|---|
| Total polyphenols | | TEAC | DPPH | FRAP | Portion | Sugars | Calories |
| mg GAE/100 | ppm | umol TE/100 | umol TE/10 | umol TE/100 mL | mL | g | Cal |

| | | | | | |
|---|---|---|---|---|---|
| Commercial juice | 1961 | 19614 | 250 | 7 | 0 |
| pomegranate | | | | | |
| Commercial juice | 1815 | 18155 | 236 | | 0 |
| pomegranate blueberry | | | | | |
| Commercial juice | 1313 | 13134 | 237 | | 0 |
| concord grapes | | | | | |
| Commercial juice | 525 | 5254 | 250 | | 0 |
| cranberry | | | | | |
| Commercial juice | 876 | 8756 | 250 | | 0 |
| orange | | | | | |
| Commercial juice | 2983 | 29830 | 240 | | 0 |
| aronia | | | | | |
| Commercial juice | 3170 | 31698 | 240 | | 0 |
| black currant | | | | | |

source: Abountiolas et Nascimento Nunes, 2018, Int. J. Food Sci. Technol, 53, 188

The description should be interpreted as an illustration of the present technology, but should not be considered as limiting the claims. The claims should not be limited in their scope by the examples, but should be given the broadest possible interpretation consistent with the overall description.

1. Composition based on concentrated maple sap having a polyphenol content of around 0.8 to 10 mg per g of saccharose.

2. (canceled)

3. The composition according to claim 1, in which the polyphenol content is around 0.8 to 7.0 mg per g of saccharose.

4-5. (canceled)

6. The composition according to claim 1, in which the polyphenol content is around 2.0 to 5.3 mg per g of saccharose.

7-8. (canceled)

9. The composition according to claim 1, in which the polyphenol content is around 1.0 to 2.0 mg per g of saccharose.

10-12. (canceled)

13. The composition according to claim 1, said composition having a phosphorus content of around 0.02 to 0.2 mg per g of saccharose.

14. (canceled)

15. The composition according to claim 1, said composition having a magnesium content of around 0.4 to 1.8 mg per g of saccharose.

16. (canceled)

17. The composition according to claim 1, said composition having an iron content of around 0.3 to 0.6 mg per g of saccharose.

18. The composition according to claim 1, said composition having a manganese content of around 0.02 to 0.7 mg per g of saccharose.

19. The composition according to claim 1, said composition having a potassium content of around 5 to 25 mg per g of saccharose.

20-21. (canceled)

22. The composition according to claim 1, said composition having a calcium content of around 3 to 10 mg per g of saccharose.

23. (canceled)

24. A composition based on concentrated maple sap having a manganese content of around 0.05 to 0.7 mg per g of saccharose.

25. The composition according to claim 24, said composition having a manganese content of around 0.1 to 0.5 mg per g of saccharose.

26. (canceled)

27. The composition according to claim 24, said composition having a magnesium content of around 0.3 to 1.8 mg per g of saccharose.

28. (canceled)

29. The composition according to claim 24, said composition having a phosphorus content of around 0.02 to 0.2 mg per g of saccharose.

30. (canceled)

31. The composition according to claim 24, said composition being in liquid form.

32. The composition according to claim 24, said composition being in solid form.

33. The composition according to claim 24, said composition being in maple syrup form.

34. The composition according to claim 24, said composition being in maple butter form.

35. The composition according to claim 24, said composition being in maple sugar form.

36. The composition according to claim 1, said composition having an antioxidant activity of at least 7000 or 7500 TE Eq., μM.

37. The composition according to claim 1, said composition having an antioxidant activity of at least 7000 or 7500 TE Eq., μM.

38. (canceled)

39. The composition according to claim 1, said composition having an antioxidant activity of around 8000 to 13000 TE Eq., μM.

40. The composition according to claim 1, said composition having an antioxidant activity of around 10000 to 12500 TE Eq., μM.

41-77. (canceled)
